(19) United States
(12) Patent Application Publication
(10) Pub. No.: US 2021/0039129 A1
(43) Pub. Date: Feb. 11, 2021

(54) HYDRO-POSITIONER AND VALVE PRECISION CONTROL APPARATUS

(71) Applicants: Mark Bolan, Princeton, TX (US); Lane Bolan, Princeton, TX (US)

(72) Inventors: Mark Bolan, Princeton, TX (US); Lane Bolan, Princeton, TX (US)

(73) Assignee: INCON-TROL CORP., McKinney, TX (US)

(21) Appl. No.: 16/938,889

(22) Filed: Jul. 24, 2020

Related U.S. Application Data
(60) Provisional application No. 62/883,052, filed on Aug. 5, 2019.

(51) Int. Cl. B05B 17/08; B05B 1/22; B05B 1/30; B05B 9/04

(52) U.S. Cl. CPC B05B 17/085; B05B 9/0403; B05B 1/302; B05B 1/22

(57) ABSTRACT

A water fountain apparatus having a controller with an input panel and running a computer application program having a communication protocol where the controller is communicatively coupled to a submersible assembly. The submersible assembly further includes a servo controller electrically coupled to the controller and being configured to transmit and receive control and power signals. The servo controller is further electrically coupled to a servo or stepper motor, operable to receive control signals from the servo controller to cause it to step clockwise or counterclockwise in steps or increments. The servo motor is coupled to a ball within a ball valve assembly via a servo shaft. The ball valve is operable to open a conduit from a manifold through one of two egress ports, or partially through both egress ports. The manifold is coupled to a pump.

### CROSS REFERENCE TO RELATED APPLICATION

This application claims the benefit of U.S. Provisional Application No. 62/883,052, titled: DISPLAY FOUNTAIN APPARATUS, ASSEMBLY AND SYSTEM, filed Aug. 5, 2019.

### TECHNICAL FIELD

The present invention relates to computer controlled hydro-positioners used for example in display fountains and systems thereof, such hydro-positioners configured for operation in a body of liquid, such as water in a natural or mar-made pond, lake and tank.

### BACKGROUND

Water displays known as dancing fountains comprise a at least one, and often a plurality of nozzles for such fountains, which nozzles ire arranged in groups. Some such nozzles are rotatably mounted about a substantially vertical axis. It is customary in dancing fountains to vary the height of the water streams rhythmically where desired, as for example, in synchronization with music or musical effects. Disadvantageously, such vertical water height is often controlled by varying the pressure applied by a pump to a water flow.

What is desired is an apparatus, assembly and system operable to vary the height of the water streams from a central controller platform, using a precision ball valve wherein the mechanical components for effecting the ejection of water through a ball valve and nozzle from a pump/manifold are submersible and wherein the volume of the conduit through the ball of the ball valve is dynamically variable using computer based instructions. The invention provides such an apparatus, assembly and system.

### SUMMARY

The present invention is an apparatus, assembly and system that will produce one or a variety of vertical spray of different heights from a water fountain nozzle. The apparatus, assembly and system is operable to vary the height of the water streams using a central controller platform communicable coupled to a submersible housing having therein a servo controller and servo, the servo operable to dynamically rotate a ball in a ball valve, the ball having a conduit through which a stream of water is directed for ejection through a nozzle. The location of the ball in a certain position allows a high volume of water to traverse the conduit, a portion thereof to traverse the conduit and another portion to be blocked, or all of the stream of water to be blocked. A manifold having a pump coupled to an ingress thereof provides the source of pressurized water, and th egress of the manifold is coupled to the ball valve.

The mechanical components for effecting the ejection of water from the pump/manifold is submersible. The invention is an apparatus, assembly and system operable to vary the height of the water streams from a central controller platform, using a precision ball valve wherein the mechanical components for effecting the ejection of water through a ball valve and nozzle from a pump/manifold is submersible and wherein the volume of the conduit through the ball of the ball valve is dynamically variable. The apparatus, assembly and system of the present invention is operable to control the height of water spray from at least one, and often a plurality, of water fountain(s). A novel characteristic of the invention is submersible housing and components therein which are coupled to a controller to allow for the selective adjustability of the water flow supplying the nozzle(s). In a system of multiple nozzles, the water flow to one or a group of nozzles are controlled or adjusted independently of dial to the other groups of nozzles by using, per nozzle, a servo controller coupled to servo and thence to a ball in a ball valve as described herein.

Additional objects and advantages of the invention will become apparent during the course of the following specification when taken in connection with the accompanying drawings. To those skilled in the art to which this invention relates, many changes in construction and widely differing embodiments and applications of the invention will suggest themselves without departing from the scope of the invention as defined herein. The disclosures and the descriptions herein are purely illustrative and are not intended to be in any sense limiting.

### BRIEF DESCRIPTION OF THE DRAWINGS

For a better understanding of the present invention including the features, advantages and specific embodiments, reference is made to the following description along with accompanying drawings.

FIG. 1 is an overview of the hydro-positioner and valve control apparatus and system in one embodiment of the present invention.

FIG. 2 is a perspective view of a submersible assembly and optional connected 3-way ball valve in one embodiment of the present invention.

FIG. 3a is a side planform view of a submersible assembly and optional connected three-way ball valve in one embodiment of the present invention.

FIG. 3b is a top planform view of a submersible assembly and optional connected three-way ball valve defining a section cutaway plane in one embodiment of the present invention.

FIG. 4 is a cutaway planform view of a submersible assembly and optional connected three-way ball valve corresponding to the section cutaway plane in FIG. 3b, in one embodiment of the present invention.

FIG. 5 is a diagram of a submersible assembly, optional connected three-way ball valve, and ingress manifold in one embodiment of the present invention.

FIG. 6 is a side planform view of the base of a submersible assembly in one embodiment of the present invention.

### DETAILED DESCRIPTION

While the making and using of the disclosed embodiment of the invention is discussed in detail below, it should be appreciated that the invention provides many applicable inventive concepts which can be embodied in a wide variety of specific contexts. Some features of the disclosed embodiment shown and discussed may be simplified or exaggerated for illustrating the principles of the invention.

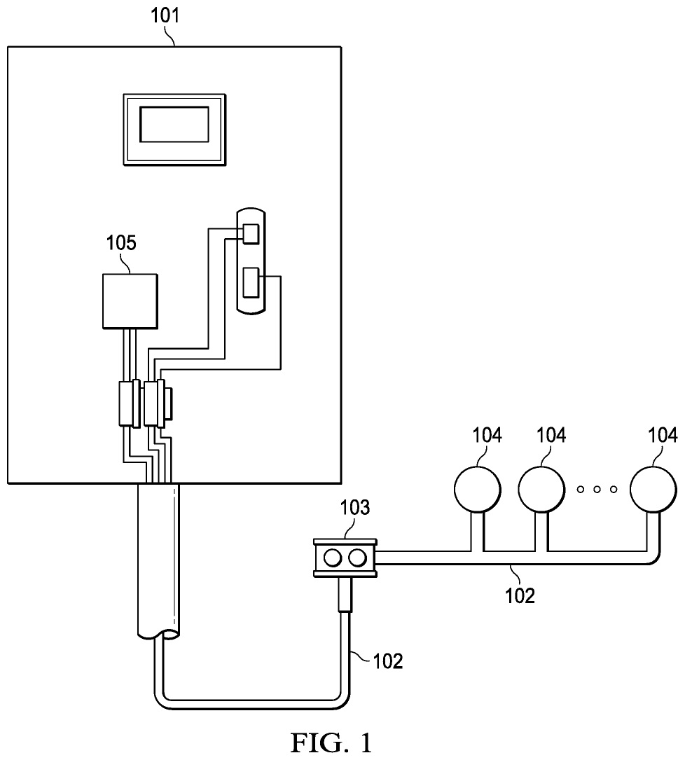

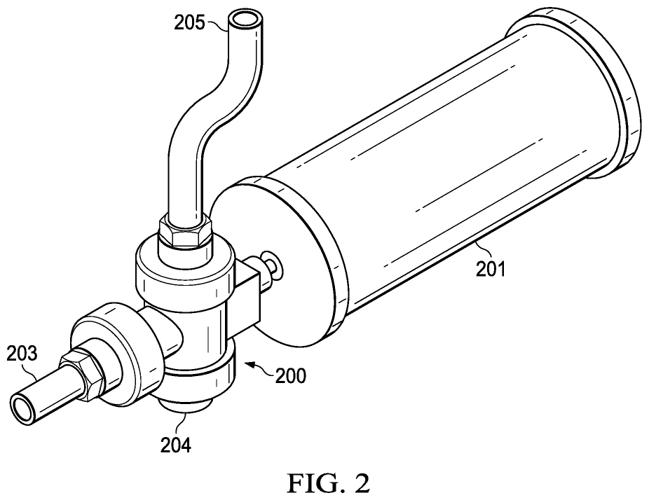

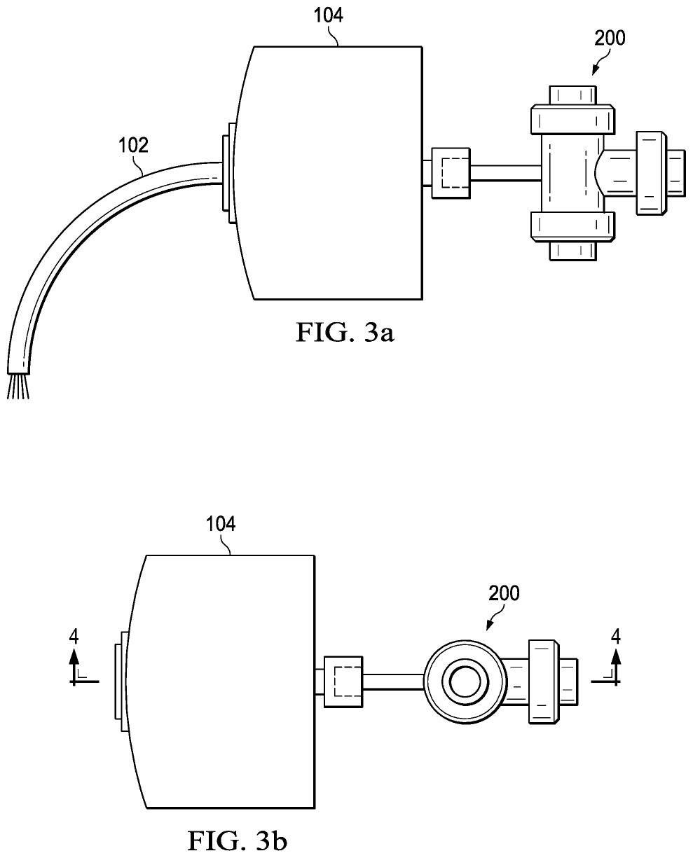

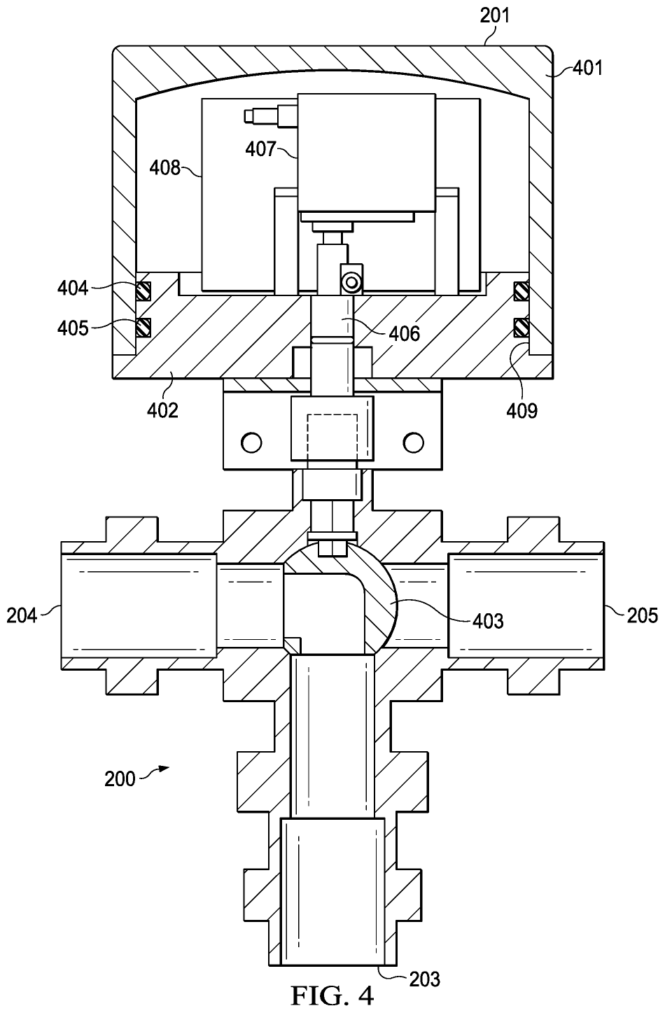

Referring to FIG. 1, the invention is a water fountain apparatus, assembly and system comprising a controller 105 having an input panel 101 operable to execute a computer application program having a communication protocol, the controller 105 being communicatively coupled via submersible cables 102 to, in one embodiment of the present invention, a submersible junction box 103 which carries communication signals and power to one or more submersible hydro-positioner assemblies 104, housed in a submersible housing 201. It further comprises one or more submersible hydro-positioner assemblies 104 that, referring to FIG. 4, further includes a servo controller 408 electrically coupled to the controller 105 and being configured to transmit and receive control and power signals via submersible cables 102. The servo controller 408 is electrically coupled to a servo or stepper motor 407, operable to receive signals to from the servo controller to cause it to step clockwise or counterclockwise in steps or increments. The servo motor is coupled to a ball 403 within a ball valve assembly 200 via a servo shaft 406, the ball valve operable to open a conduit from a manifold 501 via an ingress port 203 through one of two egress ports 204, 205, or partially through both egress ports.

A manifold 501 is coupled between an egress thereto and ingress 203 to the ball valve assembly 200. A pump 502 is coupled to an ingress 503 to the manifold 501. The pump can be located above the water or can be a submersible pump. The servo controller 408, servo motor 407 and a partial length of the servo shaft 406, are housed within a water or liquid impermeable, submersible housing 201. The servo shaft extends from the servo motor to outside the submersible housing and is coupled to the ball within the ball valve assembly. The controller includes a computer application program having an operating system and a communication protocol which comprise instructions stored on a computer readable medium operable to be executed by a microprocessor within tire controller. The servo controller is operable to execute a computer application program comprising instructions stored on a computer readable medium operable to be executed by a microprocessor within the servo controller to send signals to the servo motor. The controller and servo controller each comprise buffers, memories, registers and busses for receiving, holding, and sending control information. In an embodiment, the control signals from the servo controller to the servo motor comprise pulse width signals. Any number of fountain nozzles can utilize the invention to provide a multi-fountain display. One manifold and pump, for example, can feed a plurality of nozzles via the ball valve assembly. Further, one controller can send control signals to a plurality of hydro-controller assemblies.

More specifically, the invention comprises a controller having an input panel and operable to execute a computer application program such as an operating system and a communication protocol, such as Digital Multiplex (DMX). DMX is a standard for digital communication networks that are commonly used to control stage lighting and effects. It was originally intended as a standardized method for controlling light dimmers, which, prior to DMX512, had employed various incompatible proprietary protocols. It soon became the primary method for linking controllers (such as a lighting console) to dimmers and special effects devices such as fog machines and intelligent lights. DMX has also expanded to uses in non-theatrical interior and architectural lighting, at scales ranging from strings of Christmas lights to electronic billboards. DMX512 employs EIA-485 differential signaling at its physical layer, in conjunction with a variable-size, packet-based communication protocol. It is unidirectional.

Said controller is communicatively coupled to a submersible assembly. The submersible assembly is operable to located within a body of liquid, such as water in a natural or man-made pond, lake and tank. More specifically, the submersible assembly comprises a servo controller electrically coupled to the control panel via a communication protocol for transmitting and receiving control and power signals. The control signals are any suitable communication protocol, such as DMX or other control protocol. The power signals can be a DC power signal or an AC signal that is rectified via a transformer.

The servo controller is electrically coupled to a servo or stepper motor, operable to step clockwise or counterclockwise in steps or increments, for example, in 1.8 degree steps. Stepper motors enable accurate positioning of the motor shaft. Servo or stepper motors are used in various types of equipment for accurate rotation angle and speed control using pulse signals. Stepper motors also hold their position at stop, due to their mechanical design. Stepper motor and the associated servo controller consist of a driver which takes pulse signals in and converts them to motor motion and a stepper motor. Servos are controlled by sending an electrical pulse of variable width, or pulse width modulation (PWM), through the control wire. The servo controller can be programmed using any suitable small device programming language. Exemplary servo controllers include but not are limited to those provided by Servotronix, Arduino, Adafruit and Raspberry Pi.

The servo motor is coupled to a ball within a ball valve assembly via a servo shaft. The ball valve is operable to open a conduit from the manifold through one of two egress ports, or partially through both egress ports. The servo shaft is operable to rotate the ball within the ball valve assembly so as to direct the flow of water from an ingress port into the ball valve and hence the ball therein, and out one or both of a first egress port 204 (display port) or second egress port 205 (exhaust port). The first ingress port can further be extended with a nozzle for directing the water spray. The ingress port of the ball valve assembly is coupled to a manifold 501 that provides a nearly constant pressure of water from a pump 502 coupled to the ingress of the manifold. The water, at nearly constant pressure via the adjustment of the ball within the ball valve, flows through the manifold and to the ingress port of the ball valve assembly.

The servo controller, servo motor and a partial length of the servo shaft, are housed within a water or liquid impermeable, submersible housing 201. The servo shaft extends from the servo motor to outside the submersible housing and is coupled to the ball within the ball valve assembly. When the ball valve is in a first position, water entering into the ball valve assembly, and thence the ball, from the manifold is directed by a conduit in the ball in the positive y-direction, thus ejecting the water skyward to a certain height dependent on, inter alia, the pressure of the water. When the ball valve is in a second position, water entering into the ball valve assembly and thence the ball, from the manifold is directed by the conduit in the ball in the negative y-direction, thus ejecting the water downward (exhaust). In any increment between the first position and the second position, water is partially ejected upward and partially ejected downward, thus varying the height of the spray. In a further embodiment, any suitable portion of the assembly, nozzle, or other component can be mounted on a platform to allow for the nozzle and hence the spray to be positioned at any direction from the vertical axis. The invention is still used to vary the height of the spray from such off-vertical direction.

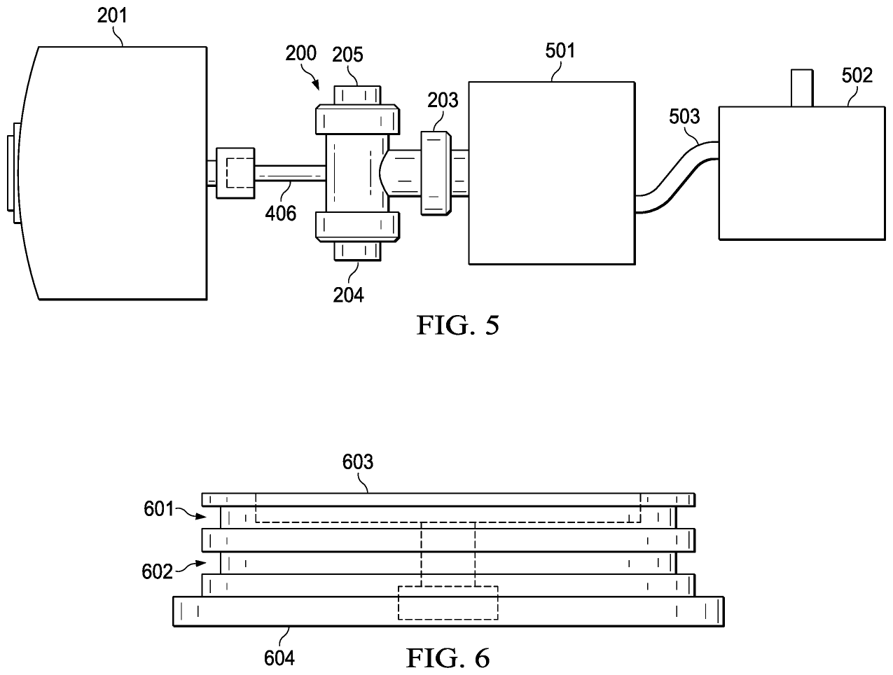

Referring to FIGS. 4, 5 and 6, the submersible housing comprises a removable cover 401 and a base 402, said base having a servo or stepper motor 407 and motor controller 408 attached thereto. The base is dimensioned as a short cylinder and defines a servo side 603 as the end of said cylinder to which said servo or stepper motor is attached and an output side 604 as the side to which said ball valve is attached. The base further comprises two concentric grooves 601 and 602 set into the outer lateral surface of said cylinder, said grooves being spaced apart longitudinally and each admitting an O-ring; the farther of the two O-rings from the ball valve assembly (the O-ring closer to the servo side of the base) being the water-sealing O-ring 404 which forms a tight seal between the base and tie removable cover, the nearer of the two O-rings to the ball valve assembly (the O-ring closer to the output side of the base) being the cover retention O-ring 405 which fits into a corresponding groove 409 set into the inner surface of the removable cover 401 such that the base and removeable cover are securely locked together when said cover is placed over and encloses said motor and motor controller. The cover is dimensioned as a hollow thin-walled cylinder having an open end, said cylinder having a recessed annular groove in the inner surface located toward the open end.

The invention is an apparatus, comprising a controller having an input panel operable to execute a computer application program having a communication protocol, the controller being communicatively coupled to a submersible assembly. A submersible assembly further including a servo controller is electrically coupled to the controller and being configured to transmit and receive control and power signals, the servo controller being electrically coupled to a servo or stepper motor, operable to receive signals to from the servo controller to cause it to step clockwise or counterclockwise in steps or increments. The servo motor is coupled to a ball within a ball valve assembly via a servo shaft, the ball valve is operable to open a conduit from the manifold through one of two egress ports, or partially through both egress ports.

The invention further comprises a manifold coupled between an egress thereto and an ingress to the ball valve assembly and a pump coupled to an ingress to the manifold. In an embodiment, the pump is a submersible pump. The servo controller, servo motor and a partial length of the servo shaft, are housed within a water or liquid impermeable, submersible housing. The servo shaft extends from the servo motor to outside the submersible housing and is coupled to the ball within the ball valve assembly.

The controller comprises computer hardware and software or firmware and a computer application program having a communication protocol comprising instructions stored on a computer readable medium operable to be executed by a microprocessor within the controller. The servo controller is operable to execute a computer application program comprising instructions stored on a computer readable medium operable to be executed by a microprocessor within the servo controller to send signals to the servo motor. The signals comprise pulse width signals.

In another aspect, the invention is comprised of a central controller platform, a servo controller communicably coupled to the central controller platform and located in a submersible housing and a servo coupled to the servo controller located in a submersible housing, the servo operable to dynamically rotate a ball in a ball valve assembly via a servo shaft, the ball valve assembly having an ingress and an egress and the ball having a conduit through which a flow of water is directed for ejection through a nozzle.

The ball valve assembly has an ingress, an egress and a shaft port through which a shaft from the servo is coupled to the ball within the ball valve. A nozzle is coupled to the egress of the ball valve assembly. The servo is operable to position the ball via the servo shaft and hence, the conduit there-through the ball, so as fix the volume of water to traverse the conduit into the nozzle at any moment in to time. A manifold having at least one ingress port and a plurality of egress ports, an ingress of a ball valve assembly is coupled to a corresponding egress of the manifold. A pump is coupled to the ingress port of the manifold. In an embodiment, the pump is a submersible pump. The servo controller, servo motor and a partial length of the servo shaft, are housed within a water or liquid impermeable, submersible housing. The servo shaft extends from the servo motor to outside the submersible housing and is coupled to the ball within the ball valve assembly. The submersible housing includes a first O-ring and a second O-ring between the housing and base thereof. The controller comprises hardware and software, the software being a computer application program operable to reside on a computer readable medium and having a communication protocol comprising instructions stored on a computer readable medium, being operable to be executed by a microprocessor within the controller. The servo controller is operable to execute a computer application program comprising instructions stored on a computer readable medium operable to be executed by a microprocessor within the servo controller to send signals to the servo motor.

The embodiments shown and described above are only exemplars. Even though numerous characteristics and advantages of the present invention have been set forth in the foregoing description together with details of the method of the invention, the disclosure is illustrative only and changes may be made within the principles of the invention to the full extent indicated by the broad general meaning of the terns used in the attached claim.

We claim:

1. An apparatus, comprising:
a controller having an input panel operable to execute a computer application program having a communication protocol, the controller being communicatively coupled to a submersible assembly;
a submersible assembly further including a servo controller electrically coupled to the controller and being configured to transmit and receive control and power signals, the servo controller being electrically coupled to a servo or stepper motor, operable to receive signals to from the servo controller to cause it to step clockwise or counterclockwise in steps or increments;
the servo motor coupled to a ball within a ball valve assembly via a servo shaft, the ball valve is operable to open a conduit from the manifold through one of two egress ports, or partially through both egress ports.

2. The apparatus of claim 1, further comprising a manifold coupled between an egress thereto and an ingress to the ball valve assembly.

3. The apparatus of claim 2, further comprising a pump coupled to an ingress to the manifold.

4. The apparatus of claim 3, wherein the pump is a submersible pump.

5. The apparatus of claim 1, wherein the servo controller, servo motor and a partial length of the servo shaft, are housed within a water or liquid impermeable, submersible housing.

6. The apparatus of claim 5, wherein the servo shaft extends from the servo motor to outside the submersible housing and is coupled to the ball within the ball valve assembly.

7. The water fountain apparatus of claim 1 wherein the computer application program having a communication protocol comprises instructions stored on a computer readable medium operable to be executed by a microprocessor within the controller.

8. The water fountain apparatus of claim 1 wherein the servo controller is operable to execute a computer application program comprising instructions stored on a computer readable medium operable to be executed by a microprocessor within the servo controller to send signals to the servo motor.

9. The water fountain apparatus of claim 8, wherein the signals comprise pulse width signals.

10. A water fountain system, comprising:
a central controller platform;
a servo controller communicable coupled to the central controller platform and located in a submersible housing;
a servo coupled to the servo controller located in a submersible housing, the servo operable to dynamically rotate a ball in a ball valve assembly via a servo shaft, the ball valve assembly having an ingress and an egress and the ball having a conduit through which a flow of water is directed for ejection through a nozzle.

11. The water fountain system of claim 10, wherein the ball valve assembly has an ingress, an egress and a shaft port through which a shaft from the servo is coupled to the ball within the ball valve.

12. The water fountain system of claim 11, wherein a nozzle is coupled to the egress of the ball valve assembly.

13. The water fountain system of claim 12, wherein the servo is operable to position the ball via the servo shaft and hence, the conduit there-through the ball so as fix the volume of water to traverse the conduit into the nozzle at any moment in to time.

14. The water fountain system of claim 13, further comprising a manifold having at least one ingress port and a plurality of egress ports, an ingress of a ball valve assembly being coupled to a corresponding egress of the manifold.

15. The water fountain system of claim 14, further comprising a pump coupled to the ingress port of the manifold.

16. The water fountain system of claim 15, wherein the pump is a submersible pump.

17. The water fountain system of claim 16, wherein the servo controller, servo motor and a partial length of the servo shaft, are housed within a water or liquid impermeable, submersible housing.

18. The water fountain system of claim 17, wherein the servo shaft extends from the servo motor to outside the submersible housing and is coupled to the ball within the ball valve assembly.

10. The water fountain system of claim 10, wherein the submersible housing includes a first O-ring and a second O-ring between the housing and base thereof.

20. The water fountain system of claim 10, wherein the controller comprises hardware and software, the software being a computer application program operable to reside on a computer readable medium and having a communication protocol comprising instructions stored on a computer readable medium, being operable to be executed by a microprocessor within the controller, further wherein the servo controller is operable to execute a computer application program comprising instructions stored on a computer readable medium operable to be executed by a microprocessor within the servo controller to send signals to the servo motor.
